(19) United States
(12) Patent Application Publication
(10) Pub. No.: US 2026/0106721 A1
(43) Pub. Date: Apr. 16, 2026

(54) APPARATUS AND METHOD OF WIRELESS COMMUNICATION

(71) Applicant: GUANGDONG OPPO MOBILE TELECOMMUNICATIONS CORP., LTD., Dongguan (CN)

(72) Inventor: Li GUO, Allen, TX (US)

(21) Appl. No.: 19/418,554

(22) Filed: Dec. 12, 2025

Related U.S. Application Data
(63) Continuation of application No. PCT/CN2024/103878, filed on Jul. 5, 2024.
(60) Provisional application No. 63/525,357, filed on Jul. 6, 2023.

(51) Int. Cl. H04L 5/00

(52) U.S. Cl. CPC H04L 5/0096

(57) ABSTRACT

A method of wireless communication of a user equipment (UE) includes receiving a configuration of one or more transmission control indication (TCI) states from a base station and transmitting a first message to the base station. The first message indicates at least one of the one or more TCI states for an uplink/downlink communication with the base station.

### CROSS-REFERENCE TO RELATED APPLICATIONS

This application is a continuation of International Patent Application No. PCT/CN2024/103878, filed on July 05, 2024, which claims priority to U.S. Provisional Patent Application No. 63/525,357, filed on July 06, 2023, the disclosures of which are hereby incorporated by reference in their entirety.

### BACKGROUND

One drawback of a current method of beam indication/updating is that a base station controls a beam switch and updating, even though the base station may not know a beam quality with a high-degree of accuracy. This may cause various challenges. For instance, a beam indication operation might cause large signaling overhead and large latency. As another example, a system might switch to wrong beam due to lack of latest beam quality information.

### SUMMARY

The present disclosure relates to the field of communication systems, and more particularly, to apparatuses and methods of wireless communication.

In a first aspect of the present disclosure, a method of wireless communication of a user equipment (UE) includes receiving a configuration of one or more transmission control indication (TCI) states from a base station and transmitting a first message to the base station, wherein the first message indicates at least one of the one or more TCI states for an uplink/downlink communication with the base station.

In a second aspect of the present disclosure, a UE includes a memory, a transceiver and a processor coupled to the memory and the transceiver. The processor is configured to control the transceiver to: receive a configuration of one or more transmission control indication (TCI) states from a base station; and transmit a first message to the base station, wherein the first message indicates at least one of the one or more TCI states for an uplink/downlink communication with the base station.

In a third aspect of the present disclosure, a base station includes a memory, a transceiver and a processor coupled to the memory and the transceiver. The processor is configured to control the transceiver to: transmit, to a user equipment (UE), a configuration of one or more transmission control indication (TCI) states; and receive a first message from the UE, wherein the first message indicates at least one of the one or more TCI states based on one or more quality factors for an uplink/downlink communication with the UE.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a block diagram of one or more user equipment (UE) and a base station of communication in a communication network system according to an embodiment of the present disclosure.

FIG. 2 is a block diagram of a UE according to an embodiment of the present disclosure.

FIG. 3 is a block diagram of a UE according to an embodiment of the present disclosure.

FIG. 4 is a flowchart illustrating a method of wireless communication performed by a UE according to an embodiment of the present disclosure.

FIG. 5 is a block diagram of a base station according to an embodiment of the present disclosure.

FIG. 6 is a block diagram of a base station according to an embodiment of the present disclosure.

FIG. 7 is a flowchart illustrating a method of wireless communication performed by a base station according to an embodiment of the present disclosure.

FIG. 8 illustrates a procedure of user equipment (UE)-driven transmission control indication (TCI) state switch according to some methods presented in some embodiments of the present disclosure.

FIG. 9 is a block diagram of an example of a computing device according to an embodiment of the present disclosure.

FIG. 10 is a block diagram of a communication system according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

The technical solutions of the embodiments of the present disclosure can be applied to various communication systems, such as a global system of mobile communication (GSM) system, a code division multiple access (CDMA) system, a wideband code division multiple access (WCDMA) system, a general packet radio service (GPRS), a long term evolution (LTE) system, a LTE frequency division duplex (FDD) system, a LTE time division duplex (TDD) system, an advanced long term evolution (LTE-A) system, a new radio (NR) system, an evolution system of a NR system, a LTE-based access to unlicensed spectrum (LTE-U) system, a NR-based access to unlicensed spectrum (NR-U) system, an universal mobile telecommunication system (UMTS), a global interoperability for microwave access (WiMAX) communication system, wireless local area networks (WLAN), wireless fidelity (Wi-Fi), a future 5th generation (5G) system (may also be called a new radio (NR) system) or other communication systems, etc.

Optionally, a base station mentioned in the embodiments of the present application can provide a communication coverage for a specific geographic area and can communicate with a user equipment (UE) located in the coverage area. Optionally, the base station may be a gNB, a base transceiver station (BTS) in the GSM or in the CDMA system, or may be a NodeB (NB) in the WCDMA system, or may be an evolutional Node B (eNB or eNodeB) in the LTE system, or a radio controller in a cloud radio access network (CRAN).

A user equipment (UE) may refer to an access terminal, a subscriber unit, a subscriber station, a mobile station, a remote station, a remote terminal, a mobile device, a user terminal, a terminal, a wireless communication device, a user agent, or a user device. The access terminal may be a cellular radio telephone, a cordless telephone, a session initiation protocol (SIP) telephone, a wireless local loop (WLL) station, a personal digital assistant (PDA), a handheld device with wireless communication functions, a computing device, other processing devices coupled with a wireless modem, an in-vehicle device, a wearable device, a terminal device in a future 5G network, a terminal device in a future evolved public land mobile network (PLMN), etc.

Optionally, the communication system in the embodiment of the present application may be applied to an unlicensed spectrum, where the unlicensed spectrum may also be considered as a shared spectrum; or the communication system in the embodiment of the present application may also be applied to a licensed spectrum, where the licensed spectrum can also be considered an unshared spectrum.

New radio (NR)/fifth generation (5G) system supports a frequency range 2 (FR2) operation. The NR/5G system in FR2 is generally a multi-beam-based system, where a base station such as a gNB has multiple downlink transmit (Tx) beams that are available for downlink transmission, and a user equipment (UE) may have multiple Rx beams available for downlink transmission reception. For uplink transmission, the UE may have multiple Tx beams available for transmission, and the gNB has multiple uplink Rx beams that are available for uplink reception. To support proper communication, the gNB and the UE may find the best pair of gNB Tx beam and UE Rx beam. In the NR/5G system, beam measurement and reporting in channel state information (CSI) framework is introduced to support the selection of best Tx beam and Rx beam. The NR/5G system may also support functions of beam indication for downlink reception and uplink transmission. The gNB can indicate information of Tx beam of a physical downlink control channel (PDCCH) and a physical downlink shared channel (PDSCH) to the UE to assist the downlink reception at the UE side. The gNB can also indicate the information of Tx beam of a physical uplink shared channel (PUSCH), a physical uplink control channel (PUCCH), and a sounding reference signal (SRS) to the UE to indicate the UE about how to transmit the PUSCH, PUCCH, and SRS.

The NR/5G system may implement function of a beam indication through signaling of transmission control indication (TCI) states. The UE can be first provided with a list of joint TCI states or a list of downlink (DL) TCI states and a list of uplink (UL) TCI states. Each joint TCI state can provide a configuration information of quasi co-location (QCL) type D for downlink reception (where the QCL type D provides a spatial receive (Rx) parameter for downlink reception) and a reference information of UL Tx spatial filter for uplink transmission. Each joint TCI state can be associated with a set of uplink power control parameters, including Reference Signal (P0), alpha, an index of closed loop power control, and a pathloss reference signal (RS). Each DL TCI state can provide the configuration information of QCL type D for downlink reception. Each UL TCI state can provide the reference information of UL Tx spatial filter for uplink transmission, and each UL TCI state can also be associated with a set of uplink power control parameters, including P0, alpha, index of closed loop, and pathloss RS.

The gNB can indicate on joint TCI state or a pair of DL TCI states and UL TCI states to the UE through a downlink control information (DCI) signaling. When the UE receives the DCI signaling for TCI state indication, the UE feedbacks one acknowledge (ACK) to the gNB. Then, the indicated TCI state(s) can be applied starting from a first slot that is at least beamAppTime symbols after last symbols of the PUCCH or PUSCH that carries the ACK. From the information of QCL Type D in the indicated TCI state, the UE would derive the Rx beam for receiving the PDCCH and PDSCH. From the information of UL Tx spatial filter in the indicated TCI state, the UE would derive the Tx beam for transmitting the PUSCH, PUCCH, and/or SRS. From the indicated TCI state, the UE would derive uplink power control parameters and pathloss RS and then calculate the uplink transmit power for the PUSCH transmission, the PUCCH transmission, and/or the SRS transmission.

The NR/5G system also supports a function of multi-component carrier (CC) TCI state update, which is used to reduce the latency and signaling overhead of TCI state indication. The gNB can indicate one joint TCI state or a pair of DL TCI state and UL TCI state to the UE through the DCI signaling. Further, the indicated TCI state is applied to the reception of PDCCH and PDSCH and/or transmission of PUSCH, PUCCH, and/or SRS in multiple CCs.

One drawback of a current method of beam indication/updating is that a base station controls a beam switch and updating, even though the base station may not know a beam quality with a high-degree of accuracy. This may cause various challenges. For instance, a beam indication operation might cause large signaling overhead and large latency. As another example, a system might switch to wrong beam due to lack of latest beam quality information.

Therefore, there is a need for apparatuses and methods of wireless communication.

An object of the present disclosure is to propose apparatuses and methods of wireless communication, which can solve issues in the prior art and other issues, support a system to switch to the best beam for downlink transmission and/or an uplink transmission with low latency and low signaling overhead, and/or improve a performance of the system.

FIG. 1 illustrates that, in some embodiments, one or more user equipment (UE) 10 and a base station (e.g., next generation NodeB (gNB) or eNB) 20 of communication in a communication network system 30 (e.g., an NR system) according to an embodiment of the present disclosure are provided. The communication network system 30 includes the one or more UEs 10 and the base station 20. The one or more UEs 10 may include a memory 12, a transceiver 13, and a processor 11 coupled to the memory 12 and the transceiver 13. The base station 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

In some embodiments, the transceiver 13 is configured to receive a configuration of one or more transmission control indication (TCI) states from the base station 20 and transmit a first message to the base station 20, wherein the first message indicates at least one of the one or more TCI states for an uplink/downlink communication with the base station 20. This can solve issues in the prior art and other issues, support a system to switch to the best beam for downlink transmission and/or an uplink transmission with low latency and low signaling overhead, and/or improve a performance of the system.

In some embodiments, the transceiver 23 is configured to transmit, to the UE 10, a configuration of one or more transmission control indication (TCI) states and receive a first message from the UE 10, wherein the first message indicates at least one of the one or more TCI states based on one or more quality factors for an uplink/downlink communication with the UE 10. This can solve issues in the prior art and other issues, support a system to switch to the best beam for downlink transmission and/or an uplink transmission with low latency and low signaling overhead, and/or improve a performance of the system.

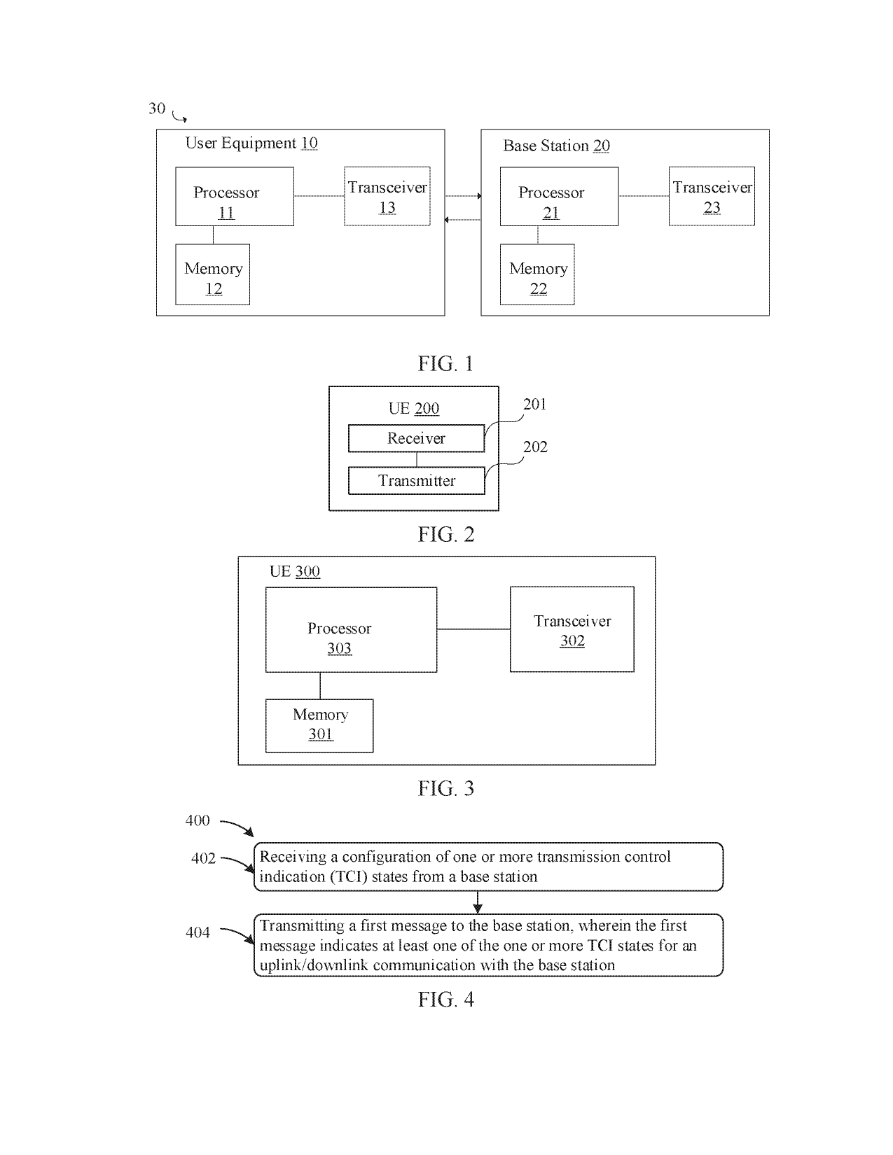

FIG. 2 illustrates an example of a UE 200 according to an embodiment of the present application. The UE 200 is configured to implement some embodiments of the disclosure. Some embodiments of the disclosure may be implemented into the UE 200 using any suitably configured hardware and/or software. The UE 200 includes a receiver 201 and a transmitter 202. The receiver 201 is configured to receive a configuration of one or more transmission control indication (TCI) states from a base station, and the transmitter 202 is configured to transmit a first message to the base station, wherein the first message indicates at least one of the one or more TCI states for an uplink/downlink communication with the base station. This can solve issues in the prior art and other issues, support a system to switch to the best beam for downlink transmission and/or an uplink transmission with low latency and low signaling overhead, and/or improve a performance of the system.

FIG. 3 illustrates an example of a UE 300 according to an embodiment of the present disclosure. The UE 300 is configured to implement some embodiments of the disclosure. Some embodiments of the disclosure may be implemented into the UE 300 using any suitably configured hardware and/or software. The UE 300 may include a memory 301, a transceiver 302, and a processor 303 coupled to the memory 301 and the transceiver 302. The processor 303 may be configured to implement proposed functions, procedures and/or methods described in this description. Layers of radio interface protocol may be implemented in the processor 303. The memory 301 is operatively coupled with the processor 303 and stores a variety of information to operate the processor 303. The transceiver 302 is operatively coupled with the processor 303, and the transceiver 302 transmits and/or receives a radio signal. The processor 303 may include application-specific integrated circuit (ASIC), other chipset, logic circuit and/or data processing device. The memory 301 may include read-only memory (ROM), random access memory (RAM), flash memory, memory card, storage medium and/or other storage device. The transceiver 302 may include baseband circuitry to process radio frequency signals. When the embodiments are implemented in software, the techniques described herein can be implemented with modules (e.g., procedures, functions, and so on) that perform the functions described herein. The modules can be stored in the memory 301 and executed by the processor 303. The memory 301 can be implemented within the processor 303 or external to the processor 303 in which case those can be communicatively coupled to the processor 303 via various means as is known in the art.

In some embodiments, the transceiver 302 is configured to receive a configuration of one or more transmission control indication (TCI) states from a base station, and the transceiver 302 is configured to transmit a first message to the base station, wherein the first message indicates at least one of the one or more TCI states for an uplink/downlink communication with the base station. This can solve issues in the prior art and other issues, support a system to switch to the best beam for downlink transmission and/or an uplink transmission with low latency and low signaling overhead, and/or improve a performance of the system.

FIG. 4 is an example of a method 400 of wireless communication performed by a UE according to an embodiment of the present disclosure. The method 400 of wireless communication performed by a UE is configured to implement some embodiments of the disclosure. Some embodiments of the disclosure may be implemented into the method 400 of wireless communication performed by a UE using any suitably configured hardware and/or software. In some embodiments, the method 400 of wireless communication performed by a UE includes: an operation 402, receiving a configuration of one or more transmission control indication (TCI) states from a base station, and an operation 404, transmitting a first message to the base station, wherein the first message indicates at least one of the one or more TCI states for an uplink/downlink communication with the base station. This can solve issues in the prior art and other issues, support a system to switch to the best beam for downlink transmission and/or an uplink transmission with low latency and low signaling overhead, and/or improve a performance of the system.

In some embodiments, the method further includes monitoring one or more quality factors associated with the one or more TCI states and identifying the at least one of the one or more TCI states for the uplink/downlink communication with the base station based on the one or more quality factors. In some embodiments, the method further includes receiving a second message from the base station, wherein the second message indicates an acknowledgement of the at least one of the one or more TCI states for the uplink/downlink communication with the base station. In some embodiments, the second message includes an acknowledge message to a physical uplink shared channel (PUSCH) carrying the first message, or the second message includes a downlink control information (DCI) signaling. In some embodiments, the method further includes performing the uplink/downlink communication with the base station based on the at least one of the one or more TCI states indicated in the first message. In some embodiments, the first message indicates a start time associated with the at least one of the one or more TCI states for the uplink/downlink communication with the base station. In some embodiments, the first message includes a media access control (MAC) control element (CE) message or an uplink control information (UCI) message.

In some embodiments, the first message includes one or more of following information fields: one identity of a serving cell for which a MAC CE applies, one downlink bandwidth part (BWP) identifier (ID) used to indicate one downlink BWP for which the MAC CE applies, one uplink BWP ID used to indicate one uplink BWP for which the MAC CE applies, one field used to indicate one TCI state ID, wherein the TCI state ID is used to identify one joint TCI state for the base station and the UE to apply, one field used to indicate one downlink TCI state ID, wherein the downlink TCI state ID is used to identify one downlink TCI state for the base station and the UE to apply, and one field used to indicate one uplink TCI state ID, wherein the uplink TCI state ID is used to identify one UL TCI state. In some embodiments, the method further includes receiving a configuration of one or more component carriers (CCs) from the base station. In some embodiments, the method further includes switching the at least one of the one or more TCI states for the uplink/downlink communication with the base station for the one or more CCs.

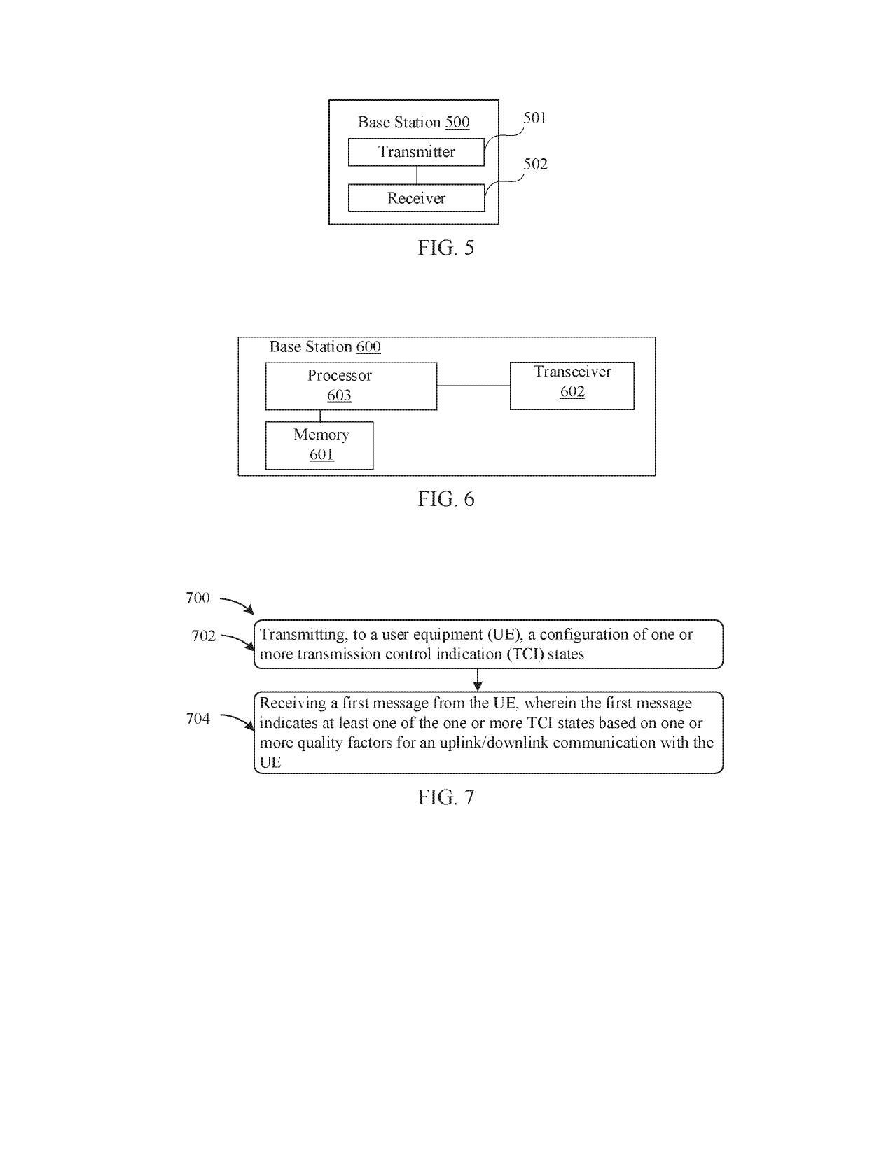

FIG. 5 illustrates an example of base station 500 according to an embodiment of the present application. The base station 500 is configured to implement some embodiments of the disclosure. Some embodiments of the disclosure may be implemented into the base station 500 using any suitably configured hardware and/or software. The base station 500 includes a transmitter 501 and a receiver 502. The transmitter 501 is configured to transmit, to a user equipment (UE), a configuration of one or more transmission control indication (TCI) states, and the receiver 502 is configured to receive a first message from the UE, wherein the first message indicates at least one of the one or more TCI states based on one or more quality factors for an uplink/downlink communication with the UE. This can solve issues in the prior art and other issues, support a system to switch to the best beam for downlink transmission and/or an uplink transmission with low latency and low signaling overhead, and/or improve a performance of the system.

FIG. 6 illustrates an example of a base station 600 according to an embodiment of the present disclosure. The base station 600 is configured to implement some embodiments of the disclosure. Some embodiments of the disclosure may be implemented into the base station 600 using any suitably configured hardware and/or software. The base station 600 may include a memory 601, a transceiver 602, and a processor 603 coupled to the memory 601 and the transceiver 602. The processor 603 may be configured to implement proposed functions, procedures and/or methods described in this description. Layers of radio interface protocol may be implemented in the processor 603. The memory 601 is operatively coupled with the processor 603 and stores a variety of information to operate the processor 603. The transceiver 602 is operatively coupled with the processor 603, and the transceiver 602 transmits and/or receives a radio signal. The processor 603 may include application-specific integrated circuit (ASIC), other chipset, logic circuit and/or data processing device. The memory 601 may include read-only memory (ROM), random access memory (RAM), flash memory, memory card, storage medium and/or other storage device. The transceiver 602 may include baseband circuitry to process radio frequency signals. When the embodiments are implemented in software, the techniques described herein can be implemented with modules (e.g., procedures, functions, and so on) that perform the functions described herein. The modules can be stored in the memory 601 and executed by the processor 603. The memory 601 can be implemented within the processor 603 or external to the processor 603 in which case those can be communicatively coupled to the processor 603 via various means as is known in the art.

In some embodiments, the transceiver 602 is configured to transmit, to a user equipment (UE), a configuration of one or more transmission control indication (TCI) states and receive a first message from the UE, wherein the first message indicates at least one of the one or more TCI states based on one or more quality factors for an uplink/downlink communication with the UE. This can solve issues in the prior art and other issues, support a system to switch to the best beam for downlink transmission and/or an uplink transmission with low latency and low signaling overhead, and/or improve a performance of the system.

FIG. 7 is an example of a method 700 of wireless communication performed by a base station according to an embodiment of the present disclosure. The method 700 of wireless communication performed by the base station is configured to implement some embodiments of the disclosure. Some embodiments of the disclosure may be implemented into the method 700 of wireless communication performed by the base station using any suitably configured hardware and/or software. In some embodiments, the method 700 of wireless communication performed by the base station includes: an operation 702, transmitting, to a user equipment (UE), a configuration of one or more transmission control indication (TCI) states, an operation 704, receiving a first message from the UE, wherein the first message indicates at least one of the one or more TCI states based on one or more quality factors for an uplink/downlink communication with the UE. This can solve issues in the prior art and other issues, support a system to switch to the best beam for downlink transmission and/or an uplink transmission with low latency and low signaling overhead, and/or improve a performance of the system.

In some embodiments, the method further includes generating a second message, wherein the second message indicates an acknowledgement of the at least one of the one or more TCI states for the uplink/downlink communication with the UE. In some embodiments, the second message includes an acknowledge message to a physical uplink shared channel (PUSCH) carrying the first message, or the second message includes a downlink control information (DCI) signaling. In some embodiments, the method further includes performing the uplink/downlink communication with the UE based on the at least one of the one or more TCI states indicated in the first message. In some embodiments, performing the uplink/downlink communication with the UE based on the at least one of the one or more TCI states indicated in the first message includes: initiating the uplink/downlink communication with the UE based on the at least one of the one or more TCI states at a start time indicated in the first message. In some embodiments, the first message indicates a start time associated with the at least one of the one or more TCI states for the uplink/downlink communication with the UE. In some embodiments, the first message includes a media access control (MAC) control element (CE) message or an uplink control information (UCI) message.

In some embodiments, the first message includes one or more of following information fields: one identity of a serving cell for which a MAC CE applies, one downlink bandwidth part (BWP) identifier (ID) used to indicate one downlink BWP for which the MAC CE applies, one uplink BWP ID used to indicate one uplink BWP for which the MAC CE applies, one field used to indicate one TCI state ID, wherein the TCI state ID is used to identify one joint TCI state for the base station and the UE to apply, one field used to indicate one downlink TCI state ID, wherein the downlink TCI state ID is used to identify one downlink TCI state for the base station and the UE to apply, and one field used to indicate one uplink TCI state ID, wherein the uplink TCI state ID is used to identify one UL TCI state. In some embodiments, the method further includes transmitting, to the UE, a configuration of one or more component carriers (CCs). In some embodiments, the method further includes requesting the UE to switch the at least one of the one or more TCI states for the uplink/downlink communication with the UE for the one or more CCs.

### Exemplary Technical Solutions:

In some embodiments, a UE can be requested to indicate one Tx beam for downlink transmission and one Tx beam for uplink transmission to the base station and the base station/UE switch the Tx beam to the Tx beam indicated by the UE starting from some time point. The base station may configure one or more TCI states to the UE. One TCI state can provide the configuration of QCL Type D to the UE, which can be used by the UE to derive the Rx beam for downlink reception. One TCI state can provide the configuration information that provides a reference for determining UL Tx spatial filter for uplink transmission. The TCI state can be a joint TCI state, which may provide the configuration of QCL Type D, and also a reference for determining UL Tx spatial filter for uplink transmission. The TCI state may be a DL TCI state that provides the configuration of QCL TypeD to the UE. The TCI state can be a UL TCI state that can provide a reference for determining UL Tx spatial filter for uplink transmission. A joint TCI state can be associated with a set of uplink power control parameters and pathloss RS. A UL TCI state can be associated with a set of uplink power control parameters and pathloss RS. The UE can be requested to monitor the quality of some downlink RS.

In some embodiments, when the UE finds some Tx beam are good (e.g., meets one or more criteria) for downlink and/uplink transmission, the UE can indicate the information of the Tx beam to the base station. The UE can indicate one joint TCI state to the base station and indicate the base station that the downlink transmission and uplink transmission can be switched to the indicated joint TCI state. When the base station receives the indication message of the UE, the base station can send a acknowledge message to the UE. Then, starting from some time point, the base station and the UE apply the indicated joint TCI state on downlink transmission and uplink transmission. The UE can indicate one pair of DL TCI state and UL TCI state to the base station, and the UE can indicate the base station that the downlink transmission and uplink transmission can be switched to the indicated DL and UL TCI states. When the base station receives the indication message of the UE, the base station can send a acknowledge message to the UE. Then, starting from some time point, the base station and the UE apply the indicated DL TCI state on downlink transmission and indicated UL TCI state on uplink transmission.

In one example, the base station can activate one or more joint TCI states and the UE can indicate one of the activated joint TCI states to the base station that indicate the base station that the base station and the UE shall switch to the indicated joint TCI states starting from some time point. In one example, the base station can activate one or more pairs of DL TCI state and UL TCI state, and the UE can report one activated pair of DL TCI state and UL TCI state to the base station that indicate the base station that the base station and the UE may switch the downlink transmission and uplink transmission to the reported DL TCI state and UL TCI state. In one example, the UE can report on joint TCI state for multiple CCs. The UE reports one joint TCI state to the base station that indicates that the base station and UE shall apply the indicated joint TCI state on downlink and uplink transmission in multiple CCs. A list of CCs can be provided to the UE through RRC configuration. The UE can be requested to operate a procedure to determine that the current TCI state is not good and to determine a good TCI state. In one example, the UE can monitor the quality of RS corresponding to the current TCI state and a first TCI state. If the quality of RS corresponding the first TCI state is better than the quality of RS corresponding to the current TCI state for a given time duration, the UE can determine that the first TCI state is good candidate to switch to.

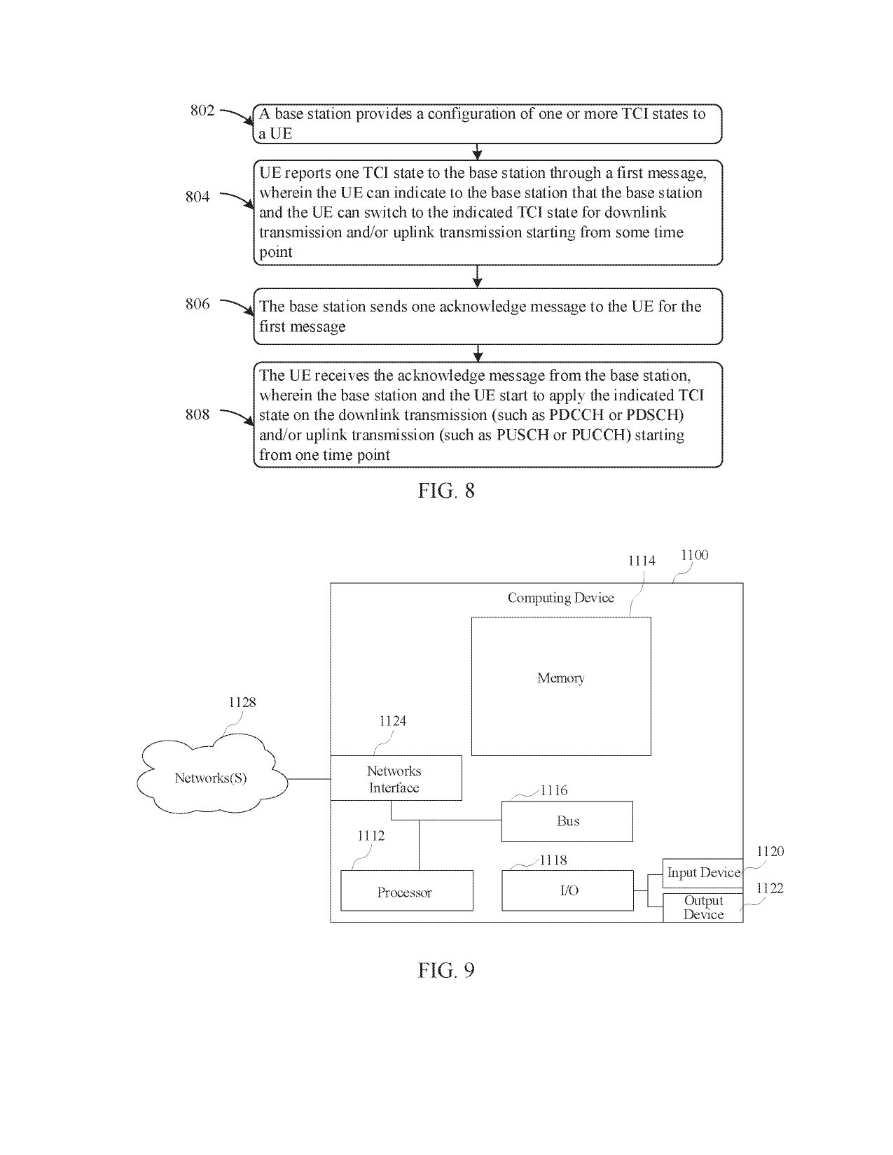

FIG. 8 illustrates a procedure of UE-driven TCI state switch according to some methods presented in some embodiments of the present disclosure. FIG. 8 illustrates that, in some embodiments, the procedure may include an operation 802, a base station provides a configuration of one or more TCI states to a UE, an operation 804, the UE reports one TCI state to the base station through a first message, wherein the UE can indicate to the base station that the base station and the UE can switch to the indicated TCI state for downlink transmission and/or uplink transmission starting from some time point, an operation 806, the base station sends one acknowledge message to the UE for the first message, an operation 808, the UE receives the acknowledge message from the base station, wherein the base station and the UE start to apply the indicated TCI state on the downlink transmission (such as PDCCH or PDSCH) and/or uplink transmission (such as PUSCH or PUCCH) starting from one time point. This can solve issues in the prior art and other issues, support a system to switch to the best beam for downlink transmission and/or an uplink transmission with low latency and low signaling overhead, and/or improve a performance of the system.

In some embodiments, in a first method, the base station can provide a list of N joint TCI states to the UE. The UE can be requested to report the indicator of a first joint TCI state to the base station through a MAC CE message. This MAC CE can be called TCI state switch MAC CE. This MAC CE message can include one or more of the following information fields: one identity of the Serving Cell for which the MAC CE applies, one DL BWP ID to indicate the DL BWP for which the MAC CE applies, one UL BWP ID that indicates one UL BWP for which the MAC CE applies, and one field that indicates one TCI state ID that can identify one joint TCI state for the base station and UE to apply.

In some embodiments, when the base station receives the MAC CE message, the base station can send one acknowledge message for the MAC CE message to the UE. In one example, the acknowledge message can be the acknowledge message to the PUSCH that carries the MAC CE message. In one example, the acknowledge message can be a DCI signaling. The reported joint TCI state can be applied on PDCCH, PDSCH, PUSCH and/or PUCCH starting from the first slot that is at least K symbols after the last symbol of the acknowledge message. In another example, the base station can provide a list of N1 DL TCI states and a list of N2 UL TCI states to the UE. The UE can be requested to report the indicator of a DL TCI state and a UL TCI state to the base station through a MAC CE message. This MAC CE can be called TCI state switch MAC CE. This MAC CE message can include one or more of the following information fields: one identity of the Serving Cell for which the MAC CE applies, one DL BWP ID to indicate the DL BWP for which the MAC CE applies, one UL BWP ID that indicates one UL BWP for which the MAC CE applies, one field that indicates one DL TCI state ID that can identify one DL TCI state for the base station and UE to apply, and one field that indicates one UL TCI state ID that can identify one UL TCI state.

In some embodiments, the reported DL TCI state can be applied on PDCCH and PDSCH starting from the first slot that is at least K symbols after the last symbol of the acknowledge message. The reported UL TCI state can be applied on PUSCH and PUCCH starting from the first slot that is at least K symbols after the last symbol of the acknowledge message.

In one example, the UE can be configured with zero, one or more SR (scheduling request) configurations. For TCI state switch reporting, PUCCH resource for SR can be configured. When the UE has MAC CE of TCI state switch to transmit, the UE can send SR in the PUCCH resource for SR configured for this event.

In some embodiments, in a second method, the base station can provide a list of N joint TCI states to the UE. The UE can be requested to report the indicator of a first joint TCI state to the base station through a UCI message. The UCI message can be sent in a PUCCH resource. The reported joint TCI state can be applied on PDCCH, PDSCH, PUSCH and PUCCH starting from the first slot that is at least K1 symbols after the last symbol of the PUCCH transmission. In another example, the base station can provide a list of N1 DL TCI states and a list of N2 UL TCI states to the UE. The UE can be requested to report the indicator of a DL TCI state and a UL TCI state to the base station through a UCI message and the UCI message can be sent in a PUCCH transmission. The reported DL TCI state can be applied on PDCCH, PDSCH starting from the first slot that is at least K1 symbols after the last symbol of the PUCCH transmission carrying the TCI state reporting UCI and the reported UL TCI state can be applied on PUSCH, PUCCH starting from the first slot that is at least K1 symbols after the last symbol of the PUCCH transmission carrying the TCI state reporting UCI.

In one example, UE can report the TCI state through a 2-part UCI, which contains a first part of the UCI and a second part of the UCI. The first part of the UCI can indicate whether the second part of the UCI exist in one PUCCH transmission and the second part of the UCI can report one joint TCI state or a pair of DL TCI state and UL TCI state. For example, the UE can be configured with two PUCCH resource: a first PUCCH resource and a second PUCCH resource for the UE to report TCI state. In the first PUCCH resource, the UE reports the first part of the UCI of TCI state reporting. If the first part of the UCI indicate that the second part of the UCI exists, the UE can report the ID of one joint TCI state or an ID of one DL TCI state and an ID of one UL TCI state in the second part of the UCI.

In some embodiments, in a third method, the UE can be configured to report TCI state to switch the TCI state for multiple CCs. The UE can be provided with a first list of CCs. The base station can provide a list of N joint TCI states to the UE. The UE can be requested to report the indicator of a first joint TCI state to the base station in MAC CE message, according to the first method. The reported joint TCI state can be applied on PDCCH, PDSCH, PUSCH and PUCCH in all the CCs contained in the first list starting from the first slot that is at least K symbols after the last symbol of the acknowledge message of the MAC CE message. In another example, the base station can provide a list of N1 DL TCI states and a list of N2 UL TCI states to the UE. The UE can be requested to report the indicator of a DL TCI state and a UL TCI state to the base station through a MAC CE message. The reported DL TCI state can be applied on PDCCH and PDSCH in all the CCs contained in the first list starting from the first slot that is at least K symbols after the last symbol of the acknowledge message of the MAC CE message, and the reported UL TCI state can be applied on PUSCH and PUCCH in all the CCs contained in the first list starting from the first slot that is at least K symbols after the last symbol of the acknowledge message of the MAC CE message.

In another example, the base station can provide a list of N joint TCI states to the UE. The UE can be requested to report the indicator of a first joint TCI state to the base station in UCI message, according to the second method. The reported joint TCI state can be applied on PDCCH, PDSCH, PUSCH and PUCCH in all the CCs contained in the first list starting from the first slot that is at least K symbols after the last symbol of the UCI message. In another example, the base station can provide a list of N1 DL TCI states and a list of N2 UL TCI states to the UE. The UE can be requested to report the indicator of a DL TCI state and a UL TCI state to the base station through a UCI message. The reported DL TCI state can be applied on PDCCH and PDSCH in all the CCs contained in the first list starting from the first slot that is at least K symbols after the last symbol of the UCI message, and the reported UL TCI state can be applied on PUSCH and PUCCH in all the CCs contained in the first list starting from the first slot that is at least K symbols after the last symbol of the UCI message.

In summary, some embodiment of the present disclosure may provide solutions for user driven TCI update and switch. The UE can be provided with a list of TCI states. When some condition is met, the UE can indicate one TCI state to the gNB (e.g., a MAC CE sent via the PUCCH). When the gNB transmits ACK to this reporting, the TCI state is applied to downlink reception and/or uplink transmission at some time point. The UE can report one TCI state, and the TCI state is applied to downlink reception and/or uplink transmission in multiple CCs. In some embodiments, the proposed methods can support the system to switch to the best beam for downlink transmission an uplink transmission with low latency and low signaling overhead and thus the performance of NR system would be improved.

An embodiment of the present disclosure further provides a non-transitory machine-readable storage medium having stored thereon instructions that, when executed by a computer, cause the computer to perform the above methods.

An embodiment of the present disclosure further provides a chip including a processor, configured to call and run a computer program stored in a memory, to cause a device in which the chip is installed to execute the above methods.

An embodiment of the present disclosure further provides a computer readable storage medium, in which a computer program is stored, for causing a computer to execute the above methods.

An embodiment of the present disclosure further provides a computer program product including a computer program, and the computer program causes a computer to execute the above methods.

An embodiment of the present disclosure further provides a computer program that causes a computer to execute the above methods.

Commercial interests for some embodiments are as follows. 1. Solve issues in the prior art and other issues. 2. Support a system to switch to the best beam for downlink transmission and/or an uplink transmission with low latency and low signaling overhead. 3. Improve a performance of the system. 4. Provide a good communication performance. 5. Provide high reliability. Some embodiments of the present disclosure can be used in many applications. Some embodiments of the present disclosure are used by chipset vendors, video system development vendors, automakers including cars, trains, trucks, buses, bicycles, moto-bikes, helmets, and etc., drones (unmanned aerial vehicles), smartphone makers, communication devices for public safety use, AR/VR/MR device maker for example gaming, conference/seminar, education purposes. Some embodiments of the present disclosure are a combination of “techniques/processes” that can be adopted in video standards to create an end product. Some embodiments of the present disclosure propose technical mechanisms. The at least one proposed solution, method, system, and apparatus of some embodiments of the present disclosure may be used for current and/or new/future standards regarding communication systems such as a UE, a base station, and/or a communication system. Compatible products follow at least one proposed solution, method, system, and apparatus of some embodiments of the present disclosure. The proposed solution, method, system, and apparatus are widely used in a UE, a base station, and/or a communication system. With the implementation of the at least one proposed solution, method, system, and apparatus of some embodiments of the present disclosure, at least one modification to methods and apparatus of wireless communication are considered for standardizing.

FIG. 9 is an example of a computing device 1100 according to an embodiment of the present disclosure. Any suitable computing device can be used for performing the operations described herein. For example, FIG. 9 illustrates an example of the computing device 1100 that can implement some embodiments of FIG. 1 to FIG. 8 using any suitably configured hardware and/or software. In some embodiments, the computing device 1100 can include a processor 1112 that is communicatively coupled to a memory 1114 and that executes computer-executable program code and/or accesses information stored in the memory 1114. The processor 1112 may include a microprocessor, an application-specific integrated circuit (“ASIC”), a state machine, or other processing device. The processor 1112 can include any of a number of processing devices, including one. Such a processor can include or may be in communication with a computer-readable medium storing instructions that, when executed by the processor 1112, cause the processor to perform the operations described herein.

The memory 1114 can include any suitable non-transitory computer-readable medium. The computer-readable medium can include any electronic, optical, magnetic, or other storage device capable of providing a processor with computer-readable instructions or other program code. Non-limiting examples of a computer-readable medium include a magnetic disk, a memory chip, a read-only memory (ROM), a random access memory (RAM), an application specific integrated circuit (ASIC), a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C#, visual basic, java, python, perl, javascript, and actionscript.

The computing device 1100 can also include a bus 1116. The bus 1116 can communicatively couple one or more components of the computing device 1100. The computing device 1100 can also include a number of external or internal devices such as input or output devices. For example, the computing device 1100 is illustrated with an input/output (“I/O”) interface 1118 that can receive input from one or more input devices 1120 or provide output to one or more output devices 1122. The one or more input devices 1120 and one or more output devices 1122 can be communicatively coupled to the I/O interface 1118. The communicative coupling can be implemented via any suitable manner (e.g., a connection via a printed circuit board, connection via a cable, communication via wireless transmissions, etc.). Non-limiting examples of input devices 1120 include a touch screen (e g., one or more cameras for imaging a touch area or pressure sensors for detecting pressure changes caused by a touch), a mouse, a keyboard, or any other device that can be used to generate input events in response to physical actions by a user of a computing device. Non-limiting examples of output devices 1122 include a liquid crystal display (LCD) screen, an external monitor, a speaker, or any other device that can be used to display or otherwise present outputs generated by a computing device.

The computing device 1100 can execute program code that configures the processor 1112 to perform one or more of the operations described above with respect to some embodiments of FIG. 1 to FIG. 8. The program code may be resident in the memory 1114 or any suitable computer-readable medium and may be executed by the processor 1112 or any other suitable processor.

The computing device 1100 can also include at least one network interface device 1124. The network interface device 1124 can include any device or group of devices suitable for establishing a wired or wireless data connection to one or more data networks 1128. Non limiting examples of the network interface device 1124 include an Ethernet network adapter, a modem, and/or the like. The computing device 1100 can transmit messages as electronic or optical signals via the network interface device 1124.

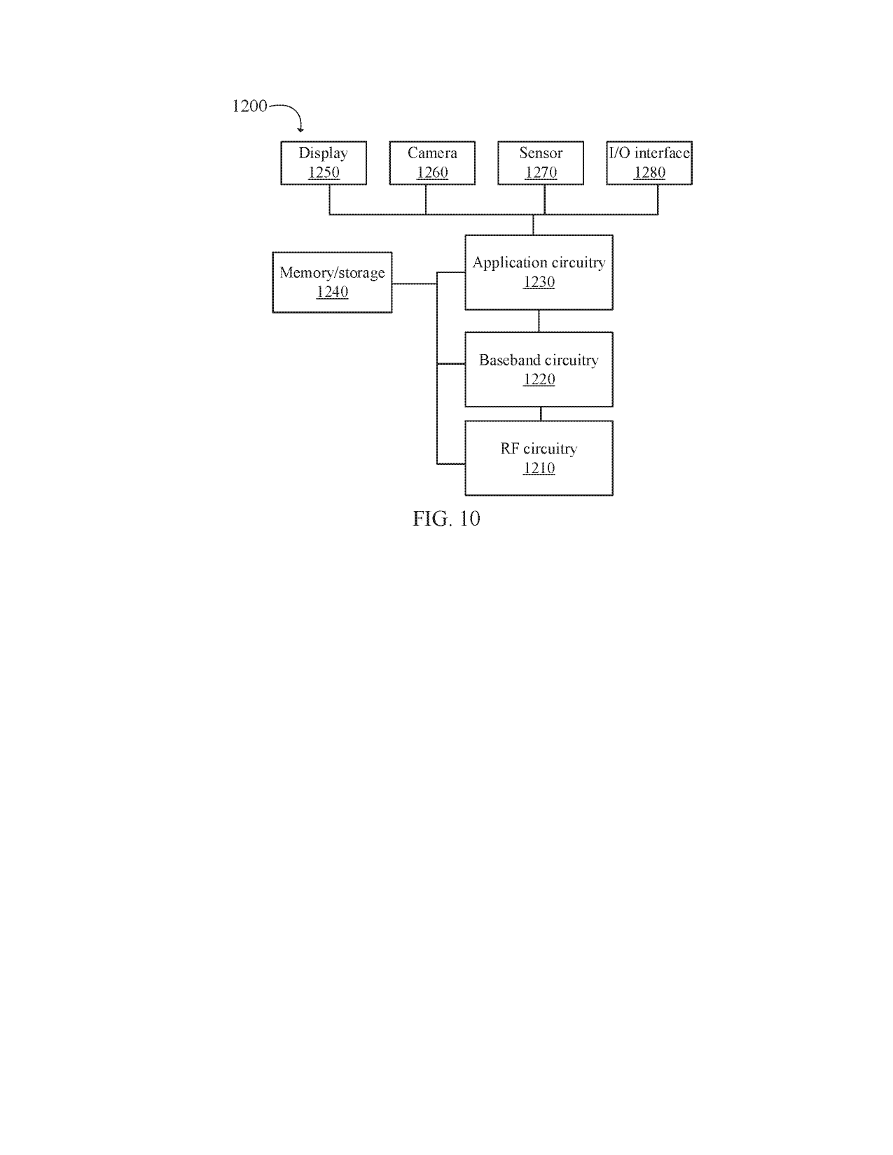

FIG. 10 is a block diagram of an example of a communication system 1200 according to an embodiment of the present disclosure. Embodiments described herein may be implemented into the communication system 1200 using any suitably configured hardware and/or software. FIG. 10 illustrates the communication system 1200 including a radio frequency (RF) circuitry 1210, a baseband circuitry 1220, an application circuitry 1230, a memory/storage 1240, a display 1250, a camera 1260, a sensor 1270, and an input/output (I/O) interface 1280, coupled with each other at least as illustrated.

The application circuitry 1230 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system. The communication system 1200 can execute program code that configures the application circuitry 1230 to perform one or more of the operations described above with respect to some embodiments of FIG. 1 to FIG. 8. The program code may be resident in the application circuitry 1230 or any suitable computer-readable medium and may be executed by the application circuitry 1230 or any other suitable processor.

The baseband circuitry 1220 may include circuitry such as, but not limited to, one or more single-core or multi-core processors. The processors may include a baseband processor. The baseband circuitry may handle various radio control functions that may enable communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 1220 may include circuitry to operate with signals that are not strictly considered as being in a baseband frequency. For example, in some embodiments, baseband circuitry may include circuitry to operate with signals having an intermediate frequency, which is between a baseband frequency and a radio frequency. The RF circuitry 1210 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 1210 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to some embodiments of FIG. 1 to FIG. 8 may be embodied in whole or in part in one or more of the RF circuitry, the baseband circuitry, and/or the application circuitry. As used herein, “circuitry” may refer to, be part of, or include an application specific integrated circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the application circuitry, and/or the memory/storage may be implemented together on a system on a chip (SOC). The memory/storage 1240 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 1280 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface. In various embodiments, the sensor 1270 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 1250 may include a display, such as a liquid crystal display and a touch screen display. In various embodiments, the communication system 1200 may be a mobile computing device such as, but not limited to, a laptop computing device, a tablet computing device, a netbook, an ultrabook, a smartphone, an AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A method of wireless communication of a user equipment (UE), comprising:
receiving a configuration of one or more transmission control indication (TCI) states from a base station; and
transmitting a first message to the base station, wherein the first message indicates at least one of the one or more TCI states for an uplink/downlink communication with the base station.

2. The method of claim 1, further comprising:
monitoring one or more quality factors associated with the one or more TCI states; and
identifying the at least one of the one or more TCI states for the uplink/downlink communication with the base station based on the one or more quality factors.

3. The method of claim 1, further comprising:
receiving a second message from the base station, wherein the second message indicates an acknowledgement of the at least one of the one or more TCI states for the uplink/downlink communication with the base station.

4. The method of claim 3, wherein the second message comprises an acknowledge message to a physical uplink shared channel (PUSCH) carrying the first message, or the second message comprises a downlink control information (DCI) signaling.

5. The method of claim 1, wherein
the first message indicates a start time associated with the at least one of the one or more TCI states for the uplink/downlink communication with the base station, and/or
the first message comprises a media access control (MAC) control element (CE) message or an uplink control information (UCI) message.

6. The method of claim 1, wherein the first message comprises one or more of following information fields:
an identity of a serving cell for which a MAC CE applies;
a downlink bandwidth part (BWP) identifier (ID) used to indicate a downlink BWP for which the MAC CE applies;
an uplink BWP ID used to indicate an uplink BWP for which the MAC CE applies;
a field used to indicate a TCI state ID, wherein the TCI state ID is used to identify a joint TCI state for the base station and the UE to apply;
a field used to indicate a downlink TCI state ID, wherein the downlink TCI state ID is used to identify a downlink TCI state for the base station and the UE to apply; and
a field used to indicate an uplink TCI state ID, wherein the uplink TCI state ID is used to identify a UL TCI state.

7. The method of claim 1, further comprising:
receiving a configuration of one or more component carriers (CCs) from the base station; and
switching the at least one of the one or more TCI states for the uplink/downlink communication with the base station for the one or more CCs.

8. A user equipment (UE), comprising:
a memory;
a transceiver; and
a processor coupled to the memory and the transceiver;
wherein the processor is configured to control the transceiver to:
receive a configuration of one or more transmission control indication (TCI) states from a base station; and
transmit a first message to the base station, wherein the first message indicates at least one of the one or more TCI states for an uplink/downlink communication with the base station.

9. The UE of claim 8, wherein the processor is further configured to:
monitor one or more quality factors associated with the one or more TCI states; and
identify the at least one of the one or more TCI states for the uplink/downlink communication with the base station based on the one or more quality factors.

10. The UE of claim 8, wherein the processor is further configured to control the transceiver to:
receive a second message from the base station, wherein the second message indicates an acknowledgement of the at least one of the one or more TCI states for the uplink/downlink communication with the base station.

11. The UE of claim 10, wherein the second message comprises an acknowledge message to a physical uplink shared channel (PUSCH) carrying the first message, or the second message comprises a downlink control information (DCI) signaling.

12. The UE of claim 8, wherein
the first message indicates a start time associated with the at least one of the one or more TCI states for the uplink/downlink communication with the base station, and/or
the first message comprises a media access control (MAC) control element (CE) message or an uplink control information (UCI) message.

13. The UE of claim 8, wherein the first message comprises one or more of following information fields:
an identity of a serving cell for which a MAC CE applies;
a downlink bandwidth part (BWP) identifier (ID) used to indicate a downlink BWP for which the MAC CE applies;
an uplink BWP ID used to indicate an uplink BWP for which the MAC CE applies;
a field used to indicate a TCI state ID, wherein the TCI state ID is used to identify a joint TCI state for the base station and the UE to apply;
a field used to indicate a downlink TCI state ID, wherein the downlink TCI state ID is used to identify a downlink TCI state for the base station and the UE to apply; and
a field used to indicate an uplink TCI state ID, wherein the uplink TCI state ID is used to identify a UL TCI state.

14. The UE of claim 8, wherein the processor is further configured to:
control the transceiver to receive a configuration of one or more component carriers (CCs) from the base station; and
switch the at least one of the one or more TCI states for the uplink/downlink communication with the base station for the one or more CCs.

15. A base station, comprising:
a memory;
a transceiver; and
a processor coupled to the memory and the transceiver;
wherein the processor is configured to control the transceiver to:
transmit, to a user equipment (UE), a configuration of one or more transmission control indication (TCI) states; and
receive a first message from the UE, wherein the first message indicates at least one of the one or more TCI states based on one or more quality factors for an uplink/downlink communication with the UE.

16. The base station of claim 15, wherein the processor is further configured to:
generate a second message, wherein
the second message indicates an acknowledgement of the at least one of the one or more TCI states for the uplink/downlink communication with the UE, and/or
the second message comprises an acknowledge message to a physical uplink shared channel (PUSCH) carrying the first message, or the second message comprises a downlink control information (DCI) signaling.

17. The base station of claim 15, wherein the processor is further configured to control the transceiver to:
perform the uplink/downlink communication with the UE based on the at least one of the one or more TCI states indicated in the first message; or
initiate the uplink/downlink communication with the UE based on the at least one of the one or more TCI states at a start time indicated in the first message.

18. The base station of claim 15, wherein
the first message indicates a start time associated with the at least one of the one or more TCI states for the uplink/downlink communication with the UE, and/or
the first message comprises a media access control (MAC) control element (CE) message or an uplink control information (UCI) message.

19. The base station of claim 15, wherein the first message comprises one or more of following information fields:
an identity of a serving cell for which a MAC CE applies;
a downlink bandwidth part (BWP) identifier (ID) used to indicate a downlink BWP for which the MAC CE applies;
an uplink BWP ID used to indicate an uplink BWP for which the MAC CE applies;
a field used to indicate a TCI state ID, wherein the TCI state ID is used to identify a joint TCI state for the base station and the UE to apply;
a field used to indicate a downlink TCI state ID, wherein the downlink TCI state ID is used to identify a downlink TCI state for the base station and the UE to apply; and
a field used to indicate an uplink TCI state ID, wherein the uplink TCI state ID is used to identify a UL TCI state.

20. The base station of claim 15, wherein the processor is further configured to:
control the transceiver to transmit, to the UE, a configuration of one or more component carriers (CCs); and
request the UE to switch the at least one of the one or more TCI states for the uplink/downlink communication with the UE for the one or more CCs.
